(19) United States
(12) Patent Application Publication
(10) Pub. No.: US 2025/0292343 A1
(43) Pub. Date: Sep. 18, 2025

(54) SYSTEMS AND METHODS FOR ASSEMBLING PROPERTY PARCELS

(71) Applicant: SCRYER, INC. DBA REONOMY, New York, NY (US)

(72) Inventors: Roger Beaman, New York, NY (US); Patrick Rafferty, New York, NY (US); Han Byul Ru, New York, NY (US); Steve Shen, New York, NY (US)

(21) Appl. No.: 18/861,442

(22) PCT Filed: Apr. 28, 2023
(86) PCT No.: PCT/US2023/020445

§ 371 Date: Oct. 29, 2024

Related U.S. Application Data
(60) Provisional application No. 63/337,009, filed on Apr. 29, 2022.

(51) Int. Cl. G06Q 50/16; G06Q 50/163

(52) U.S. Cl. CPC G06Q 50/165; G06Q 50/163

(57) ABSTRACT

Systems and methods for generating an assemblage of property parcels are disclosed. A method for implementing an assemblage includes reading a plurality of property descriptions for properties in an area and determining a shape of one or more properties based on the property descriptions. The method includes determining a spatial relationship between pairs of properties based on determined shapes of the properties and determining, based on the spatial relationship, that one or more of the property descriptions are a part of the same property.

### CROSS REFERENCE TO PRIOR APPLICATION

This application claims the benefit of U.S. Provisional Patent Application No. 63/337,009, entitled as “SYSTEMS AND METHODS FOR ASSEMBLING PROPERTY PARCELS”, filed Apr. 29, 2022, which is incorporated by reference in its entirety.

### FIELD OF THE INVENTION

This disclosure relates to the fields of data collection, processing, and combining of property descriptions.

### BACKGROUND

There are over 150 million tax parcels across the United States alone, let alone the world. However, many commercial real estate (CRE) “properties” are comprised of multiple tax parcels. In other words, there are millions of cases where multiple tax parcels act in unison together to collectively form a property; in these cases, a lone “tax parcel” may constitute but a fragment of a property. Frequently, this is a consequence of the fact that a developer “assembles” multiple tax parcels together for the purpose of developing a property, and the legal tax lots that were inputs to the development were not re-subdivided to reflect the new post-developed state. In a state where multiple tax parcels are working together to form one property, they would have the same “highest and best use”—which is to say they would not be taken to market individually. In commercial real estate, there is a theoretical concept called “highest and best use”; the Appraisal Institute defines highest and best use as follows:
The reasonably probable and legal use of vacant land or an improved property that is physically possible, appropriately supported, financially feasible, and that results in the highest value. The four criteria the highest and best use must meet are legal permissibility, physical possibility, financial feasibility, and maximum productivity. Alternatively, the probable use of land or improved property—specific with respect to the user and timing of the use—that is adequately supported and results in the highest present value.

There is an overwhelming abundance of evidence that suggests commercial real estate markets for highest and best use and the claim that properties frequently include multiple tax parcels. Tax parcels are often packaged together as part of a CRE property in commercial real estate listings to be taken to market, or valued collectively in a commercial real estate appraisal, or acts as collateral collectively for single commercial real estate loan.

But aside from the occasional market listings, there is no simple way of determining which of the multi-million tax parcels are parts of a collective property. Prospective developers must expend time and resources to figure out how tax parcels are assembled into collective properties. There is a need in the art for a fast and accurate method of resolving collective properties from tax parcel or similar data.

### SUMMARY

Disclosed are systems and methods for assembling collective properties from multiple property data descriptions. Properties with a close spatial relationship may often be combined by users for a single or best use without giving notice to a records-keeping authority. The disclosed systems and methods simplify a task of identifying real-world properties with their property descriptions.

The disclosed subject matter may be applied to properties in various areas that are not limited to a single country such as the United States. Different jurisdictions with disparate laws may organize and administrate tax parcels in various ways, but the issue of properties comprising multiple tax parcels can exist nonetheless. In Canada, for instance, each tax parcel (i.e. an assessable piece of property for property tax purposes) is identified by a roll number. A shopping center might have a separate tax roll number from its parking lot. A strata-titled property, such as a residential condominium building, in Canada may be operated as an apartment rental where each unit comprises a separately owned tax roll.

In one example in the UK, there could be 10 tax parcels on one floor of an office building with one lease. In another example, a street of office buildings could have one owner. In the UK, tax parcels are called a ‘hereditaments’ and colloquially called an assessment. The unique identifier is called a UARN (Unique Address Reference Number). There are currently approximately 2.2M UARN's in the UK. UARN's can easily split out small segments such as individual car parking spaces. These segments can be combined to be occupied or owned.

The disclosed invention generates assemblages of property parcels based on descriptions of parcels. An exemplary embodiment is a method for implementing an assemblage. The method includes reading a plurality of property descriptions for properties in an area and determining a shape of one or more properties based on the property descriptions. The method further includes determining a spatial relationship between pairs of properties based on determined shapes of the properties and determining, based on the spatial relationship, that one or more of the property descriptions are a part of the same property. The method may further include determining pairs of the properties in the area that have a same owner. Only properties with a close relationship and a same owner may be part of the same property. The close spatial relationship may include an adjacent property. The close spatial relationship may include one property containing another property. Determining that one or more of the property descriptions are a part of the same property may be performed iteratively for properties in the area. The method may further include creating a vertex and edge graph based on the spatial relationship between pairs.

Another general aspect is a computing system for implementing an assemblage. The computing system includes a processing server configured to read a plurality of property descriptions for properties in an area where the processing server is configured to determine a shape of one or more properties based on the property descriptions. The processing server is further configured to determine a spatial relationship between pairs of properties based on determined shapes of the properties and to create a vertex and edge graph based on the spatial relationship between pairs. The processing server is further configured to determine, based on the spatial relationship, that one or more of the property descriptions are a part of the same property. The processing server may be further configured to determine pairs of the properties in the area that have a same owner. Only properties with a close spatial relationship and a same owner may be determined to be part of the same property. The close spatial relationship may include an adjacent property. The close spatial relationship may include one property containing another property. Determining that one or more of the property descriptions are a part of the same property may be performed iteratively.

An exemplary embodiment is a computer readable storage medium having data stored therein representing a software executable by a computer. The software includes instructions that, when executed, cause the computer to perform reading a plurality of property descriptions for properties in an area and determining a shape of one or more properties based on the property descriptions. The instructions further cause the computer to perform determining a spatial relationship between pairs of properties based on determined shapes of the properties and determining, based on the spatial relationship, that one or more of the property descriptions are a part of the same property. The instructions may further cause the computer to perform creating a vertex and edge graph based on the spatial relationship between pairs. The instructions may further cause the computer to perform determining pairs of the properties in the area that have a same owner. Only properties with a close spatial relationship and a same owner may be determined to be part of the same property. The close spatial relationship may include an adjacent property. The close spatial relationship may include one property containing another property. The determining that one or more of the property descriptions are a part of the same property may be performed iteratively for properties in the area.

### BRIEF DESCRIPTION OF THE DRAWINGS

FIG. 1 illustrates an exemplary embodiment of the disclosed system 100 for generating assemblages of property parcels.

FIG. 2 is a flow diagram for a process of generating an assemblage of property descriptions.

FIG. 3 is a screenshot of an exemplary embodiment of property descriptions that may be combined into a collective property.

FIG. 4 is a screenshot of an exemplary embodiment of property descriptions that may be combined into a collective property.

FIG. 5 is a screenshot of an exemplary embodiment of property description that may be combined into a collective property.

FIG. 6 is a screenshot of an exemplary embodiment of property descriptions that may be combined into a collective property.

FIG. 7 is a screenshot of an exemplary embodiment of property descriptions that may be combined into a collective property.

FIG. 8 is a screenshot of an exemplary embodiment of property descriptions that may be combined into a collective property.

FIG. 9 is a screenshot of an exemplary embodiment of property descriptions that may be combined into a collective property.

FIG. 10 is a screenshot of an exemplary embodiment of property descriptions that may be combined into a collective property.

FIG. 11 is a screenshot of an exemplary embodiment of property descriptions that may be combined into a collective property.

FIG. 12 is an illustration of a computer system that may perform the disclosed process of inferring asset types.

### DETAILED DESCRIPTION

The disclosed subject matter includes systems and methods for assembling collective properties (assemblages) from multiple property data descriptions. An “assemblage” algorithm can detect which parcels have a shared highest and best use, and are acting collectively as “one property”- and therefore arrive at a better definition of a tax parcel that goes beyond the tax lot which better reflects the way CRE participants perceive commercial real estate properties. The assemblage algorithm may be applied to various property data such as tax parcel records that are generally available from government or other organizations. Other organizations may include, but are not limited to title insurance companies, various private data repositories, or the like that store property description data.

Such government or other organizations are often local, such as county treasurers, and may vary in the style and quantity of information that is recorded for various properties. Different countries will invariably organize and assess tax parcels differently. As such, the assemblage algorithm is configured to make the best of whatever information it receives from the various data sources.

Property data is collected from various data sources to be processed and organized into individual property descriptions. The disclosed system organizes the property descriptions based on the geographic location of each property description. The system processes the property data to determine adjacent properties of each property description. Once the adjacent properties are determined, they may be merged if various conditions, which indicate that the property descriptions are of a collective property, are met.

Adjacent properties are determined in various ways based on the available data. Various methods of determining include estimating a shape of the property based on the collected data and placing the determined shape relative to other properties. Other properties are similarly shaped and placed to determine adjacent properties. Properties that lack data to make a specific shape may have their shape estimated based on the area of the property. Every property description that is adjacent to another property is paired on a graph where vertices represent the properties and edges represent an adjacent pair.

In various embodiments, properties are paired based on a spatial relationship with another property. The spatial relationship may comprise sharing a boundary, having boundaries within a maximum distance of each other, having overlapping boundaries, having a boundary of one property within the boundaries of another property, and sharing the same boundaries. In an exemplary embodiment, pairs of properties that are determined to have a spatial relationship are processed to determine whether they are a collective property. Various methods may be used to analyze property description data to determine if two properties, which have a close spatial relationship, should be merged.

In an exemplary embodiment, two properties, which share a close spatial relationship such as being adjacent to one another, are merged if the two properties share a common owner. As properties often split ownership between multiple owners, the method may be configured to liberally merge properties that only share one common joint owner or restrict merger to properties that share all joint owners.

In embodiments where merging is performed based on shared ownership of only a single joint owner between properties, merging a pair of properties can introduce additional owners to adjacent properties, which could allow a merged property to be merged again. In such cases, performing the process over again may result in additional properties being merged. And each time a property is merged, there is a potential that additional pairings may be merged. Accordingly, the process may be iterated over multiple times to reach a best result.

The results of the process to determine various assembled properties do not depend on an order of operations. For example, performing the merging for multiple pairs of properties iteratively yields the same result no matter which pairs of properties are merged first. To save computational resources, iterations may be performed separately for various data sources and then combined after the data is processed. For instance, properties from various geographic regions may be processed separately. Then, once the individual geographic regions are processed, the results of all geographic regions may be processed together to return an overall result. Accordingly, the process for merging property descriptions is commutative in that the order of operations do not affect the final result.

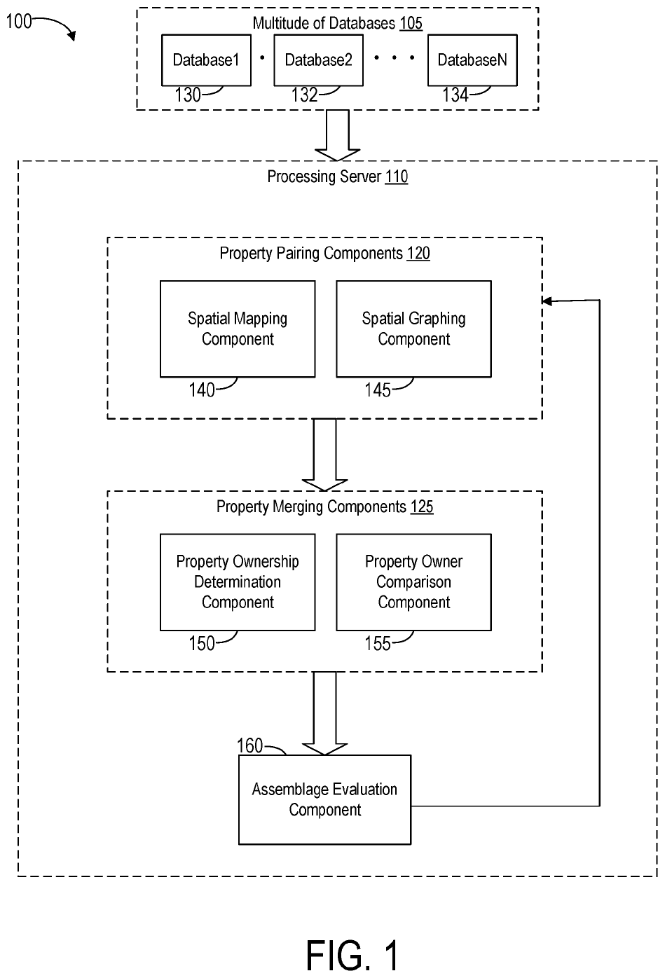

Referring to FIG. 1, FIG. 1 is an illustration of an exemplary embodiment of the disclosed system 100 for generating assemblages of property parcels. The system 100 may be implemented to resolve collective properties based on data containing the multiple property descriptions. For example, tax assessor records may be processed by the system 100 to merge one or more of the taxable properties described in the tax assessor records.

The system 100 may be implemented on multiple data sources from a multitude of databases 105 to resolve the properties described in the multitude of databases 105. In various embodiments, the multitude of databases 105 comprise county property tax records. For instance, Database1 130 may comprise the tax records of county 1, Database2 132 may comprise the tax records of county 2, and so on such that DatabaseN 134 comprises the tax records of the final county in a series of counties.

Data from the multitude of databases 105 may be transmitted to a processing server 110. The processing server 110 may comprise a processor in communication with a memory and storage. In various embodiments, the processing server 110 includes, but is not limited to a computer system, a cloud computing system, a co-located computing system, or a distributed computing system. Various iterations of the processing server 110 may be performed by different computing systems and combined later on.

In an exemplary embodiment, the processing server 110 may include property pairing components 120, property merging components 125, and an assemblage evaluation component 160. The various components of the processing server 110 may be arranged in various ways to perform the disclosed method of determining assemblages of properties based on a multitude of property descriptions.

The property pairing components 120 determine pairs of properties that may be analyzed by the property merging components 125 to determine if the pair of properties may be merged. The pairing components 120 arrange property descriptions based on the geographic positions of the properties to determine a spatial relationship between pairs of properties. Two properties that have a sufficiently close spatial relationship are passed to the property merging components 125 for further processing.

A spatial relationship may be an arrangement of properties in a geographic space. In various embodiments, the spatial relationship is based on a closest distance from an edge of one property to another property. In an exemplary embodiment, the spatial relationship is an arrangement of property boundaries in geographic relation to one another. For instance, a shape of a property may be resolved based on a property description of each property that is collected from the multitude of databases 105. The shape of each property may be spatially arranged to determine the properties that share a boundary or are sufficiently close to one another to be considered as adjacent properties. In various embodiments, properties that overlap, are contained within another property, contain another property, or share the same boundaries are all determined to have a spatial relationship to be paired and analyzed by the property merging components 125.

The Property pairing components 120 may include a spatial mapping component 140 and a spatial graphing component 145. In various embodiments, the spatial mapping component 140 may determine a shape of each property and further determine a location and rotation of the shape on a map of other properties. The spatial mapping component 140 arranges each property boundary relative to other properties on a map.

A shape of properties may be determined based on boundary descriptions in each property description. Various properties may include a survey description of a property that describes each aspect of a property boundary in detail. Some property descriptions comprise a metes and bounds of properties. In some cases, a property description is limited to an area without data that describes a shape or boundary of the property. The system 100 is configured to make the best of the data that it receives.

Property descriptions that lack a specific boundary, such as property descriptions that are limited to an area or size of a property, may be represented on a map as a circle. A spatial relationship to such properties may be limited to a distance rather than sharing a boundary for such circular property descriptions.

After arranging the properties on a map, the spatial graphing component 145 may determine a spatial relationship between each of the properties. In various examples, a spatial relationship is found when the shape of a property is adjacent to another property. In various embodiments, the spatial graphing component 145 generates a graph that efficiently describes pairs of the properties by mapping each property as a vertex and linking each pair of properties that have a spatial relationship with an edge. The graph allows the system 100 to easily retrieve pairs of properties without reanalyzing the boundaries or geographic location of the property. The graph is then passed to the property merging components 125 to determine whether properties that share a spatial relationship can be merged into a collective property.

In various embodiments, the property merging components 125 merge properties when the properties share at least one joint owner. The property merging components 125 may include a property ownership determination component 150 and a property owner comparison component 155. The property ownership determination component 150 may determine one or more owners of a property, which are passed to the property owner comparison component 155 to determine whether at least one of the determined one or more owners are similar between properties. The property ownership component may collect various information relating to an owner including, but not limited to the names of owners, the home addresses of owners, the most recent sale date, the names of owning entities, the names of individuals that control and/or own the owning entities, the entrances of the properties, branding, and community names. Shared/separate mortgages, whether lots are separated by fences or walls, and shared ingress/egress may be considered as well. All data relating to owners may be passed to the property owner comparison component 155 to determine whether there is an overlap in ownership between properties.

In an exemplary embodiment, properties are merged if they share a common joint owner. As shown in the above paragraph, data that describes owners may include more than just the names of owners. For instance, a joint owner may include a business entity such as a corporation, LLC, or a partnership. In various cases, different names may describe the same owner, especially where the owner is a business entity. Many business entities are subsidiaries or parent companies of other business entities, which may further increase the amount of data that may be compared between properties

In various embodiments, properties may be determined to share an owner if the pair of properties share data other than a name of the owner. For instance, the properties may share a joint owner that is an owning entity. In some cases, two pairs of properties may be merged where one property includes a first owning entity, and a second property includes a second owning entity that is a subsidiary or a parent company of the first owning entity. In one example of properties that may be merged, a first property is owned by a business entity and the second property includes an individual owner that is included among the owners of the business entity. In another example where a pair of properties may be merged, a first property includes the name of an individual owner, and a second property includes an owner address that is identical to the address of the individual owner for the first property.

The property owner comparison component 155 can be configured to merge or not merge properties based on various criteria. For instance, the property owner comparison component 155 can be configured to not merge properties even though the properties share a joint owner where the properties have different uses, such as where one property has a residential use and the second property has an industrial use. The property owner comparison component 155 may be configured to merge some properties where the spelling of different owner names is close. Various criteria that may be considered by the property owner comparison component 155 include, but are not limited to whether addresses of owners may be considered to merge properties, whether differently spelled owner names may be considered, whether owners of business entities may be considered against individual owners of properties, and whether subsidiaries/parent companies may be considered as the same owner.

In an exemplary embodiment, the property owner comparison component 155 may tabulate various factors that weigh in favor of merging the properties along with factors that weigh against merging the properties to determine whether or not the properties should be merged. For example, the property owner comparison component 155 may calculate a probability that a property should be merged based on various factors such as whether the properties were acquired at the same time, whether the properties have the same entrance, whether the properties are owned by a shared recorded owning entity, whether a shared ownership is a tenancy in common or a single owner, whether the properties share the same or similar branding. Additionally, the property owner comparison component 155 may include factors related to the spatial relationship between the pairs of properties. For example, pairs of properties that have an overlapping boundary or a shared boundary may have a greater weight and thus a greater probability of being merged than pairs of properties that are separated by a distance. The weight that is considered for each pair of properties may lower and even become negative as the distance between the properties increases.

In various embodiments, the property owner comparison component 155 may add weighted factors for each pair of properties to determine a probability that properties should be merged. The property owner comparison component 155 may merge the properties if the probability meets a threshold. For example, a probability threshold may be 0.8 and weights for various factors such as shared owner may be 0.7, shared entrance may be 0.3, separate mortgage may be −0.2, and connecting roads may be 0.2. The added weights in the example tabulate to 1.0, which would meet the probability and cause the property owner comparison component to merge the pair properties.

Once the property owner comparison component 155 analyzes each pair of properties and merges pairs of properties that share a joint owner, the merged property data is passed to the assemblage evaluation component 160, which determines whether the property data can be further merged. As discussed above, each pair of properties that are merged may introduce additional joint owners to the merged property and create a potential for additional mergers of properties. The assemblage evaluation component 160 determines whether the processing server 110 should iterate over the data again to determine whether further mergers are necessary. In an exemplary embodiment, the processing server 110 iterates over the data until the assemblage evaluation component 160 determines that no properties were merged in the last iteration.

In addition to iterating over the same property data multiple times, various data may be added to subsequent iterations. For instance, property data from additional geographic regions may be added to combine it with processed data to further determine properties that have spatial relationships and potentially merge them. Computational resources may be saved by stepwise processing smaller batches of data and then combining them. The assemblage evaluation component 160 may determine when each batch of data is completely processed before combining it with other property data.

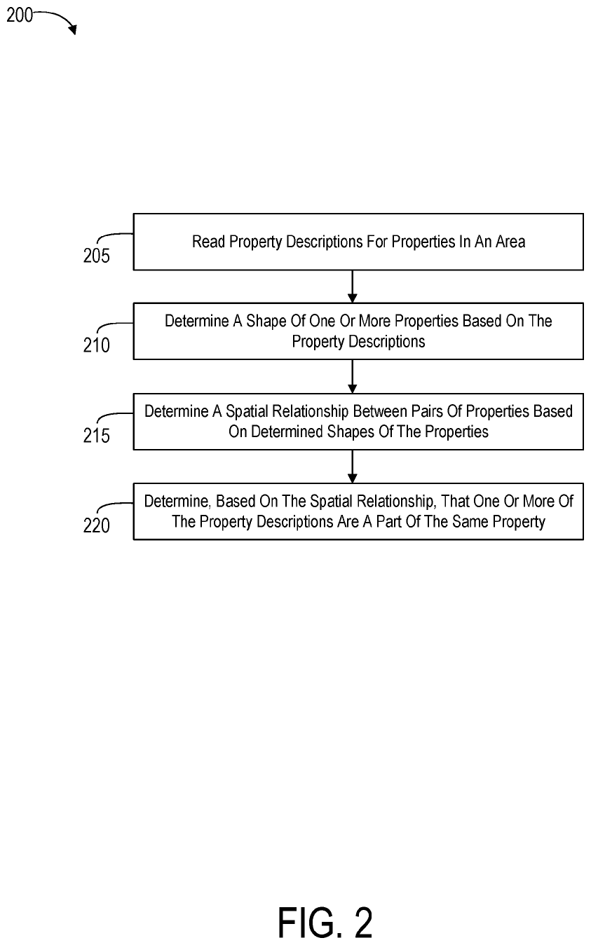

Referring to FIG. 2, FIG. 2 is a flow diagram for a process 200 of generating an assemblage of property descriptions. The process 200 may be used to merge property descriptions into collective properties. An example of use may be based on any data of property records. An example of property records may be records that are kept by various title insurance companies. At step 205, the process 200 may read property descriptions for properties in an area. In various embodiments, the processing server 110 may be configured to automatically read property records that are passed to it and begin processing them.

At step 210, the process 200 may determine a shape of the one or more properties based on the property descriptions. In various embodiments, the processing server 110 comprises a spatial mapping component 140 that processes property data to determine a shape of each property in the property data. The spatial mapping component 140 may be configured to make best use of property data such that property records that contain low or incomplete information regarding the boundaries of a property do not impede the process 200. For instance, property data that does not include any information regarding property boundaries may be represented by a simple shape such as a circle or a square.

At step 215, the process 200 may determine a spatial relationship between pairs of properties based on determined shapes of the properties. The spatial relationship is used to determine whether any pair of properties are close enough in proximity to be used as a collective property. An example of a spatial relationship are adjacent properties that share a portion of their respective boundaries. Other forms of spatial relationship include, but are not limited to closest distance between boundaries of the two properties, distance between the center of pairs of properties, any overlap between shapes of properties, a minimum amount of overlap between shapes (such as a minimum area of overlap), a shape that is contained within the shape of another property, a shape that contains the shape of another property, and properties that share the same shape and location. The spatial graphing component 145 may create a graph that stores the information of pairs of properties that share a spatial relationship. In an exemplary embodiment, the spatial graphing component 145 creates a graph comprising vertices that represent each property description and edges that connect vertices that represent spatial relationships between the connected property descriptions. Accordingly, the property merging components 125 may quickly process each pair of properties that have a spatial relationship based on the graph generated by the spatial graphing component 145.

At step 220, the process 200 may determine, based on the spatial relationship, that one or more of the property descriptions are a part of the same property. The processing server 110 may analyze each connected pair of properties from the graph created by the spatial graphing component 145 to determine whether the pair of properties share at least one joint owner. Joint owner, for the purpose of the disclosed subject matter includes a list of all individual and/or entities that share an ownership interest in the property. The term “joint owner” is not limited to joint tenants with a right of survivorship, but is intended to include all forms of shared ownership including joint tenants, tenants in common, and tenancy by the entirety. The term “joint owner” is further intended to include all forms of business ownership including, but not limited to corporations, limited liability companies (LLC's), sole proprietorships, partnerships, as well as subsidiaries and parent companies thereof.

The process 200 may merge pairs of properties that share a joint owner. Further, the process 200 may be performed multiple times on the same data because each merged property may introduce additional joint owners to pairs of properties, which can potentially result in additional mergers. In various embodiments, the processing server 110 may perform iterations until no property pairs merge in an iteration.

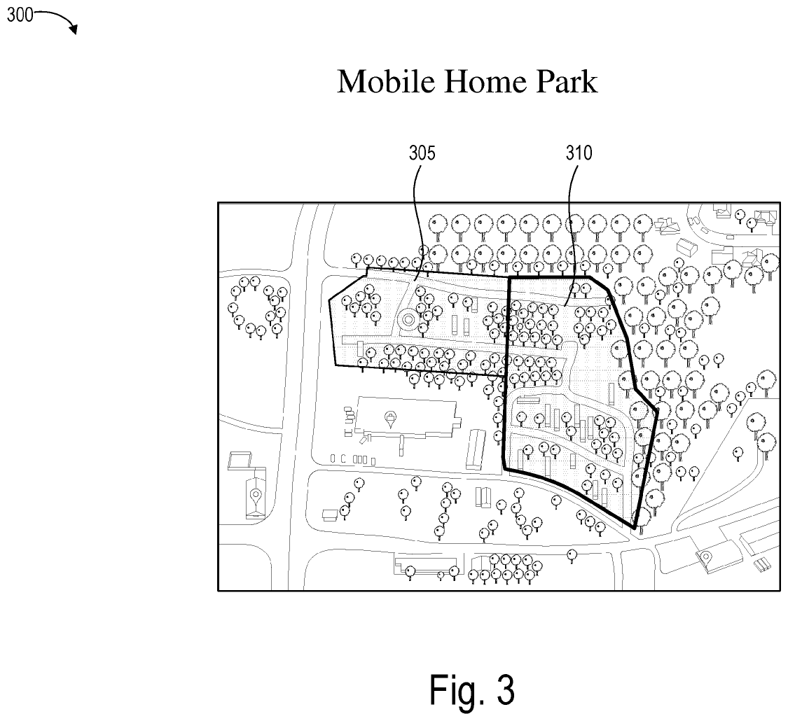

Referring to FIG. 3, FIG. 3 is a screenshot 300 of an exemplary embodiment of property descriptions that may be combined into a collective property. The screenshot 300 shows a mobile home park that spans across a first lot 305 and a second lot 310. The lots have the same recorded owning entity (ROE) and have the same most recent sale.

Thus, the property pairing components 120 would identify the lots as having a spatial relationship because they share a property boundary. Further, the property merging components 125 would be configured to merge the properties because the property data of the first lot 305 and second lot 310, which show a shared owner and a shared entrance, indicate that the two properties have been assembled into a collective use.

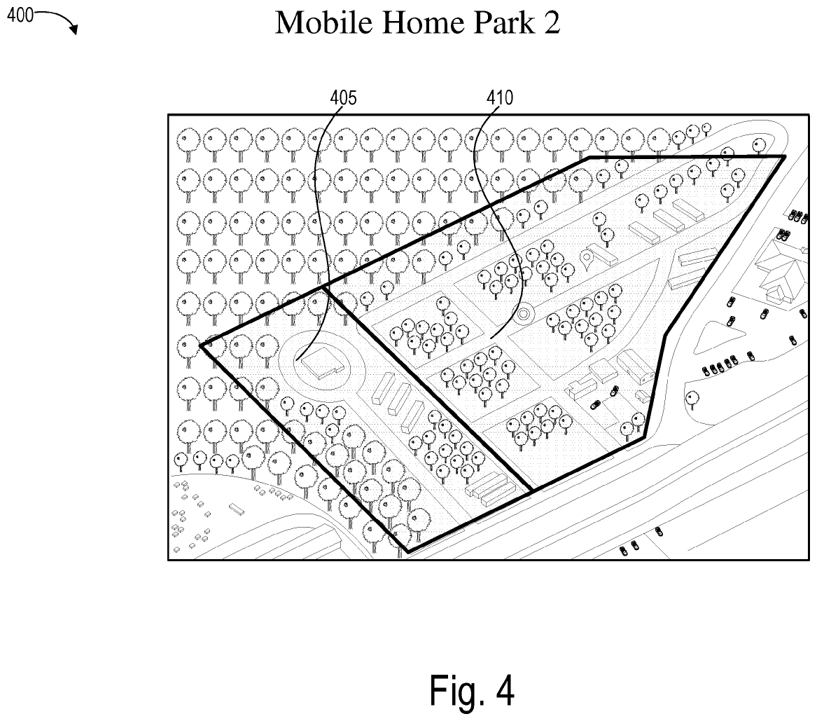

Referring to FIG. 4, FIG. 4 is a screenshot 400 of an exemplary embodiment of property descriptions that may be combined into a collective property. The screenshot 400 shows a mobile home park across two lots, a first lot 405 and a second lot 410. The 2 lots are owned by different ROE's, but the ROE's have the same individual owner. The lots have a blanket mortgage across them. The lots have different entrances with no connecting roads between the entrances. Further, the lots have different branding and community names.

The property pairing components 120 would likely pair the 2 lots because the lots are adjacent to each other. The property merging component 125 would analyze the various data of the lots to determine whether to merge the properties. In various embodiments, the property owner comparison component 155 weighs multiple factors to determine if a pair of properties should be merged. The various factors may be evaluated as a whole rather than on a one-by-one basis. The pair of lots have data that would both weigh in favor of merging the properties and data that weighs against merging the properties. For instance, the data that weighs against merging the properties includes data that the properties are owned by different ROE's with different entrances, no connecting roads, and the lots have different branding and community names.

Factors that weigh in favor of merging the properties include the ROE's have the same individual owner and the lots have a blanket mortgage across them. The property owner comparison component 155 could be configured to weigh each of the factors, for and against, to determine whether to merge the properties. In various implementations, the property owner comparison component 155 would be configured to reach a different conclusion based on weights of the different factors.

In an exemplary embodiment, a probability may be numerically determined based on weights of various factors. For example, weighted factors may be added to determine a probability. The properties are merged when the probability meets a threshold. For instance, properties may be merged if a probability is greater than 0.5. The probability may be determined by adding all weighted factors for and against merging the properties. In the exemplary example, having or not having a shared entrance may count as ±0.3 (where having a shared entrance counts as +0.3 and not having a shared entrance counts as −0.3), having or not having a connecting road may count as 0.1, having or not having a shared mortgage may count as ±0.1, having or not having a shared ROE may count as ±0.3, having an overlapping boundary or shared boundary may count as +0.5, having a boundary within 20 feet with count as +0.3. Having a boundary between 20 feet and 40 feet at the closest point may count as −0.1, having a boundary between 40 feet and 60 feet may count as −0.3, and having a boundary between 60 feet and 100 feet may count as −0.5. The various weighted factors may be determined and added for each pair of properties to determine whether or not to merge each pair of properties.

In various embodiments, a probability of spatial pairing is separated from a probability of ownership merging. For instance, the spatial graphing component 145 may tabulate a probability that properties should be paired based on weighted factors related to the spatial relationship between the properties. In an exemplary example, the spatial graphing component 145 may determine a probability based on a proximity between the two properties if the two properties do not overlap or share a boundary. The probability may be inversely proportional to a distance between the properties. The property owner comparison component 155 may further use spatial factors when it determines the probability that two properties should be merged. Accordingly, both the property owner comparison component 155 and the spatial graphing component 145 may use spatial factors in their respective determinations. For example, the property owner comparison component 155 may assign a weight of +0.5 to pairs of properties that have an overlapping boundary, which increases the probability that the properties will be merged. The spatial graphing component 145 may use a similar weight in determining whether the property should be paired.

And the property owner comparison component 155 may assign a progressively lower weight for pairs of properties based on the distance between the properties. For example, the property owner comparison component may assign a weight of +0.5 for properties that overlap, zero for properties that are separated by 40 yards and a weight of −0.5 to properties that are separated by 80 yards. Properties that are separated by distances in between those values could have interpolated weights. For instance, a pair of properties that are separated by 20 yards may be assigned a weight of +0.2 and a pair of properties that are separated by 60 yards may be assigned a weight of −0.2.

Accordingly, the property owner comparison component 155, in addition to tabulating weighted factors related to ownership, shared entrances, and the like, may also tabulate weighted factors related to the spatial relationship between the properties. Thus, paired properties may be evaluated based on their spatial relationship in spite of being already paired.

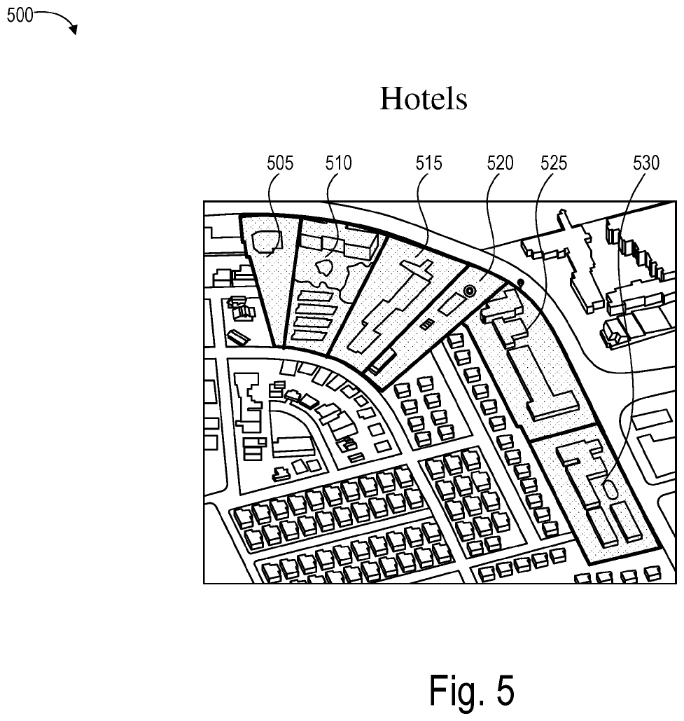

Referring to FIG. 5, FIG. 5 is a screenshot 500 of an exemplary embodiment of property descriptions that may be combined into a collective property. The screenshot 500 shows six hotel properties, a first hotel 505, a second hotel 510, a third hotel 515, a fourth hotel 520, a fifth hotel 525, and a sixth hotel 530. The six properties form one contiguous area and each individual hotel property is adjacent to at least one other hotel property. Accordingly, the property pairing components 120 would pair the various hotel properties to their adjacent neighbors whereby the property merging components 125 would evaluate whether the pairs of hotels should be merged into a collective property. Successive iterations could potentially merge all six hotel properties into a single property depending on whether the property merging components 125 determine that the individual hotel properties form a collective property.

Property data that is collected for the six hotels indicates factors that both weigh in favor of merging the hotel properties and against merging the hotel properties. Factors in favor of merging include data that the hotel properties have the same owner mailing address. Further, the hotel properties are covered by the same mortgage. Property data that weighs against merging the hotel properties includes a different owner name for each of the hotel properties, different flags (such as a different brand) at each hotel property, and separate entrances for each of the hotel properties. Various implementations of the property owner comparison component 155 could either merge the properties or decline to merge them. In the case that the hotel properties are merged, the process 200 may run multiple iterations to complete merging all of the hotel properties into a single collective property.

Accordingly, weighted factors of a same owner mailing address, the same mortgage, different branding, different owner name, and separate entrances may be tabulated to determine a probability that the properties should be merged. Weights may be assigned to each of the factors and a threshold for the probability may be set to determine an ideal scheme for merging the properties. Nothing in this disclosure should be interpreted to limit the way in which weighted factors are used to determine whether or not to merge properties. The weighted factors may be tabulated in various ways to determine whether or not properties should be merged.

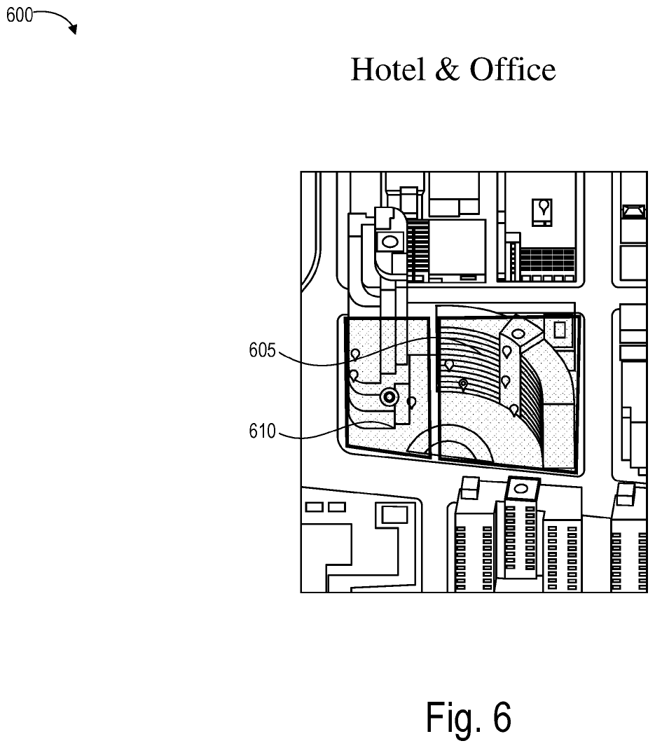

Referring to FIG. 6, FIG. 6 is a screenshot 600 of an exemplary embodiment of property descriptions that may be combined into a collective property. The screenshot 600 shows two lots: a first lot 605 is a hotel and a second lot 610 is an office building. The pair of properties would be paired by the property pairing components 120 because they are adjacent to one another. The property merging components 125 would then compare factors that weigh for and against merging the pair of adjacent properties.

Factors that weigh in favor of merging the pair of properties include data that the properties have the same reported owner and that the properties were transferred together. Factors that weigh against merging the first lot 605 and the second lot 610 include that the properties have different mortgages, that they were acquired separately, that they are different asset types (hotel and office), and that they have different entrances. The property owner comparison component 155 would balance the various data to determine whether to merge the properties. In various embodiments, the property owner comparison component 155 could be configured to return a desired result, such as merge or not merge, for similar examples.

In an exemplary embodiment, the balancing of the various data may comprise adding weighted factors that weigh in favor of merging the para properties and weighted factors that weigh against merging the para properties. In the example given above for FIG. 6, weights for the properties having the same reported owner and that the properties were transferred together would be added and weights for the properties having different mortgages, being acquired separately, having different asset types, and having different entrances would be subtracted.

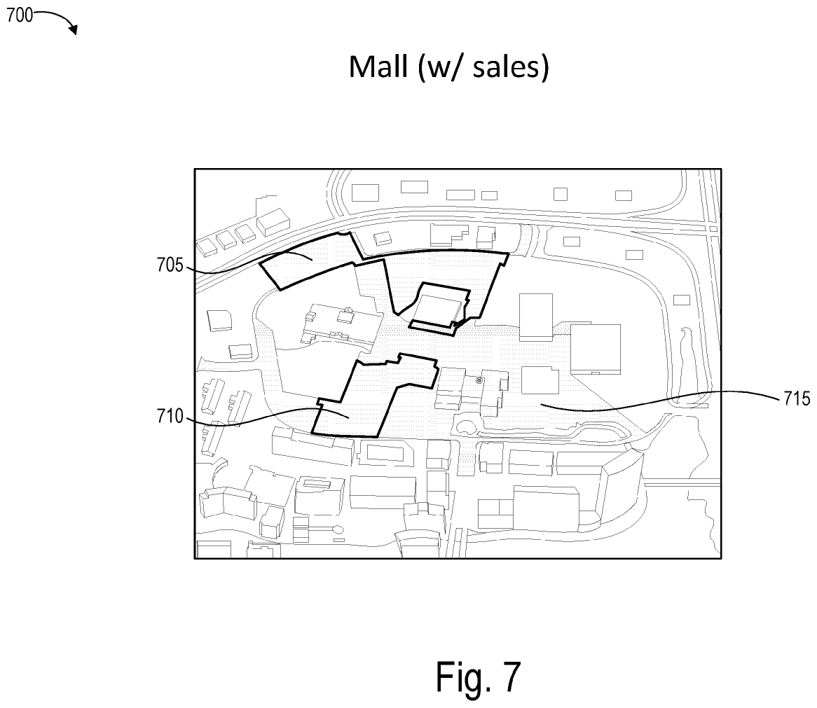

Referring to FIG. 7, FIG. 7 is a screenshot 700 of an exemplary embodiment of property descriptions that may be combined into a collective property. The screenshot 700 shows properties of a mall where property data includes sales of the various properties. The screenshot 700 includes two grouped parcels, a first grouped parcel 705 and a second grouped parcel 710. The grouped parcels represent properties that were merged by the system 100. Further, the screenshot 700 includes ungrouped parcels 715 that were not merged with the rest of the mall properties.

Each of the properties in the first grouped parcel 705 have the same reported owner name of The Woodlands Mall Associates. Accordingly, the properties of the first grouped parcel 705 were merged. Similarly, each of the properties of the second grouped parcel 710 have the same reported owner name of Woodlands Anchor Acquisition. Like the properties of the first grouped parcel, the properties of the second grouped parcel 710 were merged. The property data shows that the ungrouped parcels 715 were each sold to their respective occupants, which include Macy's, Nordstrom, JC Penney, and Dillard. Accordingly, the system 100 may partially merge various properties in a mall based on owner names and recent sales of parcels.

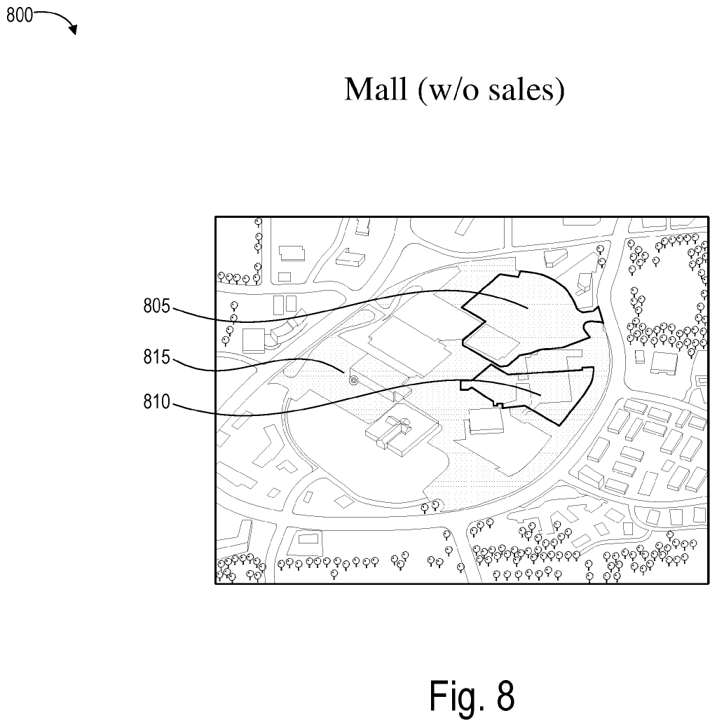

Referring to FIG. 8, is a screenshot 800 of an exemplary embodiment of property descriptions that may be combined into a collective property. The screenshot 800 shows a total of six parcels in a mall property, which include a first grouped parcel 805, a second grouped parcel 810, and ungrouped parcels 815. Property data for the ungrouped parcels 815 includes the current owners but lacks data of past sales.

The first grouped parcels 805 and the second grouped parcels 810 were merged with each other because they share the same reported owner. As shown in the screenshot 800, the first grouped parcels 805 and the second grouped parcels 810 are close in proximity, but do not share a boundary and do not overlap each other's boundaries. Thus, even though the property merging components 125 would merge the first grouped parcels 805 and the second grouped parcels 810 into one grouped parcel, they do not have a sufficient spatial relationship and would not be passed to the property merging components 125 for analysis. In various embodiments, the property pairing components 120 could be configured to pair parcels based on close proximity even if they do not share a boundary.

Factors that weigh against merging the ungrouped parcels include that all parcels have different mailing addresses. Further, the only ownership data for the the ungrouped parcels 815 includes their current occupants, which do not overlap with other reported owners. Factors that weigh in favor of merging the parcels includes that 5 of the 6 parcels share the same mortgage and the remaining parcel shares a past mortgage with a few of the other parcels.

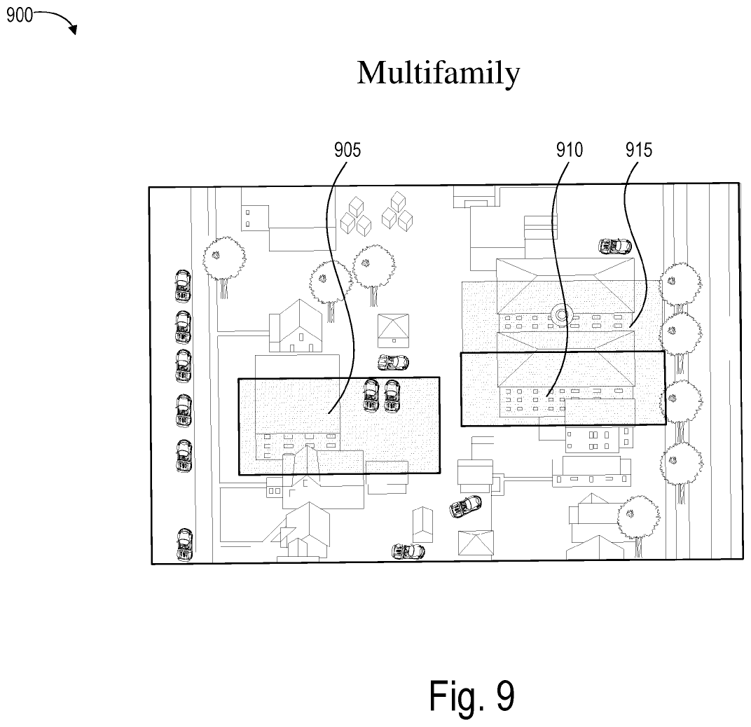

Referring to FIG. 9, FIG. 9 is a screenshot 900 of an exemplary embodiment of property descriptions that may be combined into a collective property. The screenshot 900 includes two residential properties, a first property 905 and a second property 910. The two properties are separated by a street, thus their boundaries do not overlap and the two properties do not share a boundary. However, in various implementations of the system 100, the spatial graphing component 145 may be configured to neglect roads when it considers a spatial relationship between properties. Thus, some implementations of the property pairing components 120 would pair the first property 905 and the second property 910, and pass the pair to the property merging components 125 to determine whether to merge the properties based on the collected property ownership information.

Factors that the property owner comparison component 155 would consider and weigh in favor of merging the properties include that the properties are owned by the same person. Factors that weigh against merging the properties include that even though the properties are owned by the same individual, they each have a different reported owning entity. Further, the properties have different mortgages and were sold separately from one another. Additionally, the first property 905 and second property 910 share mortgages with other properties that are adjacent to them. For instance, the second property 910 shares a mortgage with its adjacent property 915.

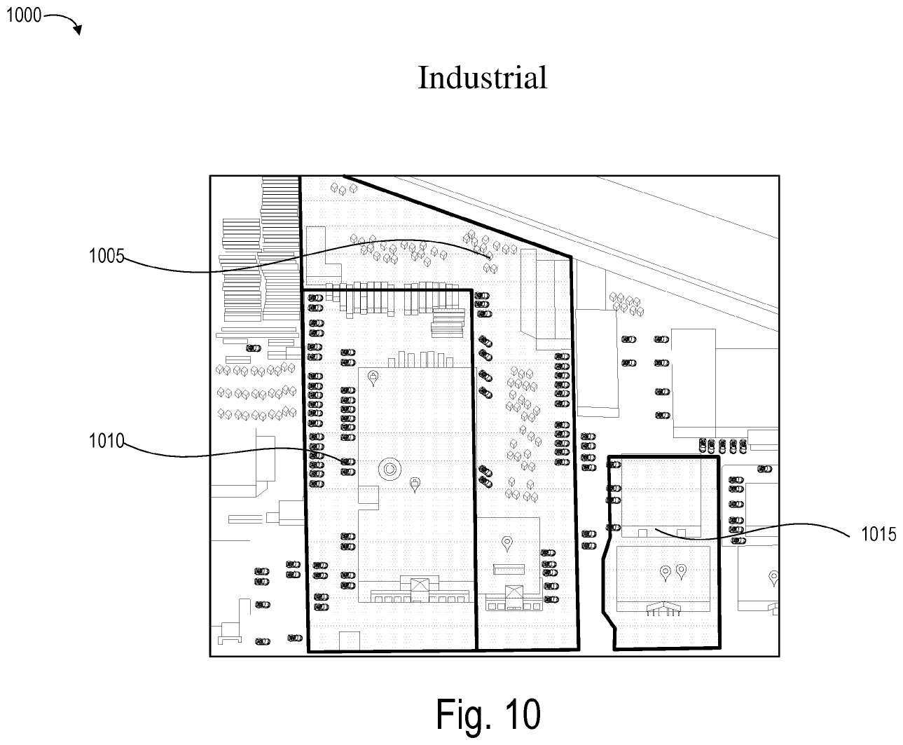

Referring to FIG. 10, FIG. 10 is a screenshot 1000 of an exemplary embodiment of property descriptions that may be combined into a collective property. The screenshot 1000 shows 3 industrial properties: a first industrial property 1005, a second industrial property 1010, and a third industrial property 1015. The first industrial property 1005 and the second industrial property 1010 share a boundary and are adjacent. The third industrial property 1015 is separated from the first industrial property 1005 by a road. As discussed above, the property pairing components 120 may be configured to neglect a road when it determines that a pair of properties are adjacent. In various embodiments, the spatial graphing component 145 is configured to neglect roads only for certain types of properties. For instance, the spatial graphing component 145 may be configured to ignore roads that separate industrial properties, but to allow roads to separate residential properties.

If the property pairing components 120 pair the three properties such that the first industrial property 1005 is adjacent to both the second industrial property 1010 and the third industrial property 1015, the property owner comparison component could weigh factors for and against merging the properties based on the following property data. All three of the properties have the same individual owner, which weighs toward merging. However, they have different reported owning entities, which weighs against merging. Additionally, each property has a separate ingress and egress with fences on the lot lines, all of which weighs against merging. Further data that weighs against merging is that the three properties were acquired in different transactions.

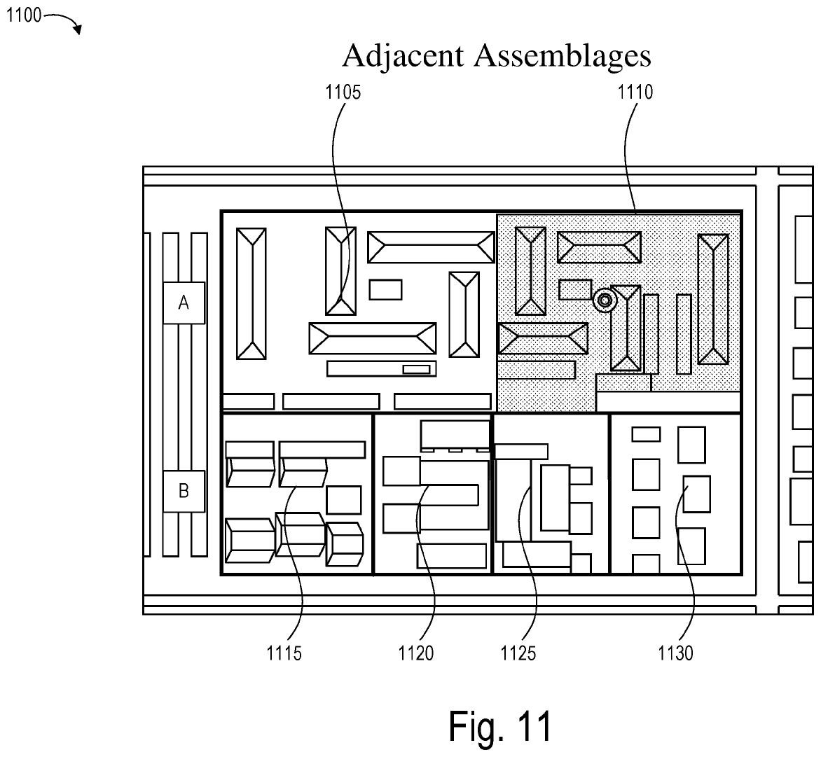

Referring to FIG. 11, FIG. 11 is a screenshot 1100 of an exemplary embodiment of property descriptions that may be combined into a collective property. Property grouping A spans 2 parcels, a first parcel 1105 and a second parcel 1110, while property grouping B spans 4 parcels, a first parcel 1115, a second parcel 1120, a third parcel 1125, and a fourth parcel 1130. The 2 parcels in property grouping A are adjacent, thus they have a spatial relationship and would be passed to the property merging components 125.

Property data for the first parcel 1105 and the second parcel 1110 indicate that they are both owned by a first entity and have a mortgage across both parcels. Both factors would weigh in favor of combining the two parcels to create an assemblage A. Property data for the first parcel 1115, the second parcel 1120, the third parcel 1125, and the fourth parcel 1130 indicate that they are all owned by a second entity and have a mortgage across all 4 parcels. Similar to assemblage A, the factors weigh in favor of combining the four parcels to create an assemblage B.

After combining the parcels to create assemblage A and B, and because they are adjacent, the system would iterate again to evaluate the pair, assemblage A and assemblage B, to determine if they should be merged. Factors that weigh against merging assemblages A and B include that they do not share any joint owners, they have separate entrances, and there appears to be a fence separating the two assemblages. Accordingly, the property owner comparison component 155 would decline to merge assemblages A and B.

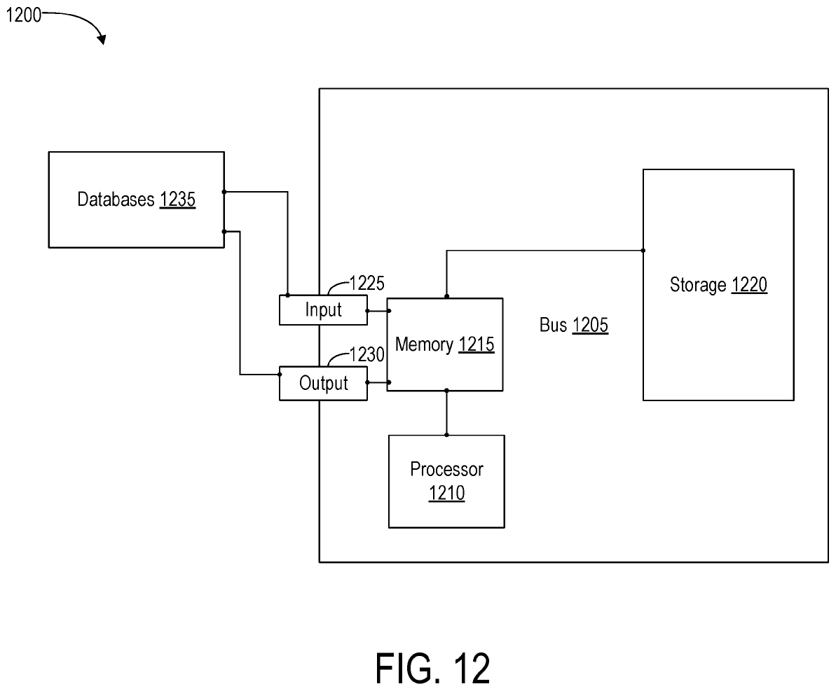

Referring to FIG. 12, FIG. 12 is an illustration of a computer system 1200 that may perform the disclosed process of generating an assemblage of property descriptions. The computer system 1200 may be a single computer system, a co-located system, a cloud-based system, a distributed system, or the like. The computer system 1200 may direct other computers in a distributed compute network to complete various processing tasks such as performing an analysis on various records.

The various components of the computer system 1200 may be linked by a bus 1205 that connects them together. The bus 1205 may connect various components based on the requirements of the components. For instance the processor 1210 may be connected to the memory 1215 through a high speed bus 1205 connection. The processor 1210 executes instructions that are transmitted to the processor 1210 from the memory 1215. The processor 1210 may be a central processing unit (CPU), a graphics processing unit (GPU), a complex programmable logic device (CPLD), a field programmable gate array (FPGA), an application-specific integrated chip (ASIC), and the like. The instructions that are executed by the processor 1210 may be transmitted through the memory 1215 to various other components of the computer system 1200.

The memory 1215 transmits instructions to be executed to the processor 1210 and transmits executed instructions from the processor 1210 to the various components of the computer system 1200. Types of memory include random access memory (RAM) and read only memory (ROM). The memory 1215 may generally direct the operation of the computer system 1200 as most data will be transmitted through the memory 1215 on its way to other components of the computer system 1200. Data may be stored in a storage 1220 for long periods without losing the data if the computer system 1200 is powered down. Types of storage may include a spinning magnetic drive and flash storage.

Data and instructions from outside the computer system 1200 may be transmitted to the memory 1215 through an input 1225. For example, records from databases 1235 may be collected through connections that traverse to the memory 1215 through the input 1225. In various embodiments, an output 1230 may transmit data to update property data in the databases 1235.

Many variations may be made to the embodiments described herein. All variations, including combinations of variations and variations that are applicable to different countries and jurisdictions, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for implementing an assemblage, the method comprising:
reading a plurality of property descriptions for properties in an area;
determining a shape of one or more properties based on the plurality property descriptions;
determining a spatial relationship between pairs of the properties based on determined shapes of the properties; and
determining, based on the spatial relationship, that one or more of the plurality of property descriptions are part of a single property.

2. The method of claim 1, further comprising determining the pairs of the properties in the area that have a shared owner.

3. The method of claim 2, wherein determining that one or more of the property descriptions are part of the single property is limited to pairs of properties with a close spatial relationship and the shared owner.

4. The method of claim 3, wherein the close spatial relationship comprises an adjacent property.

5. The method of claim 3, wherein the close spatial relationship comprises one property containing another property.

6. The method of claim 3, wherein the determining that one or more of the property descriptions are part of the single property is performed iteratively for properties in the area.

7. The method of claim 6, further comprising creating a vertex and edge graph based on the spatial relationship between the pairs of the properties.

8. A computing system for implementing an assemblage, the computing system comprising:
a processing server configured to read a plurality of property descriptions for properties in an area;
the processing server configured to determine a shape of one or more properties based on the property descriptions;
the processing server configured to determine a spatial relationship between pairs of the one or more properties based on determined shapes of the properties;
the processing server configured to create a vertex and edge graph based on the spatial relationship between pairs of the one or more properties; and
the processing server configured to determine, based on the spatial relationship, that one or more of the property descriptions are a part of a single property.

9. The computing system of claim 8, wherein the processing server is further configured to determine pairs of the one or more properties in the area that have a shared owner.

10. The computing system of claim 9, wherein only pairs of properties with a close spatial relationship and the shared owner are determined to be part of the single property.

11. The computing system of claim 10, wherein the close spatial relationship comprises an adjacent property.

12. The computing system of claim 10, wherein the close spatial relationship comprises one property containing another property.

13. The computing system of claim 10, wherein the determining that one or more of the property descriptions are part of the single property is performed iteratively.

14. A computer readable storage medium having data stored therein representing a software executable by a computer, the software comprising instructions that, when executed, cause the computer to perform:
reading a plurality of property descriptions for properties in an area;
determining a shape of one or more properties based on the property descriptions;
determining a spatial relationship between pairs of properties based on determined shapes of the properties; and
determining, based on the spatial relationship, that one or more of the property descriptions are part of a single property.

15. The computer readable storage medium of claim 14, wherein the instructions further cause the computer to perform creating a vertex and edge graph based on the spatial relationship between pairs of properties.

16. The computer readable storage medium of claim 15, wherein the instructions further cause the computer to perform determining pairs of the properties in the area that have a shared owner.

17. The computer readable storage medium of claim 16, wherein determining that one or more of the property descriptions are part of the single property is limited to pairs of properties with a close spatial relationship and the shared owner.

18. The computer readable storage medium of claim 17, wherein the close spatial relationship comprises an adjacent property.

19. The computer readable storage medium of claim 17, wherein the close spatial relationship comprises one property containing another property.

20. The computer readable storage medium of claim 17, wherein the determining that one or more of the property descriptions are part of the single property is performed iteratively for properties in the area.
